(19) United States
(12) Patent Application Publication
(10) Pub. No.: US 2006/0112269 A1
(43) Pub. Date: May 25, 2006

(54) Level-specific authentication system and method in home network

(76) Inventors: Rae-Jin Uh, Seoul (KR); Jeong-Min You, Suwon-si (KR)

Correspondence Address: Robert E. Bushnell;Suite 300, 1522 K Street, N.W., Washington, DC, 20005, US

(21) Appl. No.: 11/268,726

(22) Filed: Nov. 8, 2005

(30) Foreign Application Priority Data
Nov. 24, 2004 (KR) 2004-97153

(51) Int. Cl. H04L 9/00

(52) U.S. Cl. 713/166

(57) ABSTRACT

A level-specific authentication method in a home network includes: endowing any one of a plurality of authentication levels to each of a plurality of user stations obtaining access to an access point, and to each of a plurality of services provided by a plurality of service servers, the authentication levels being divided into a plurality of steps; and, when a given user station obtains access to the access point to make a request for the specified service, comparing the authentication level endowed to the given user station with the authentication level of the service requested by the given user station, and allowing the given user station the requested service according to a result of the comparison.

### CLAIM OF PRIORITY

This application makes reference to, incorporates the same herein, and claims all benefits accruing under 35 U.S.C. §119 from an application for LEVEL-SPECIFIC AUTHENTICATION SYSTEM AND METHOD IN HOME NETWORK earlier filed in the Korean Intellectual Property Office on 24 Nov. 2004 and there duly assigned Serial No. 10-2004-0097153.

### BACKGROUND OF THE INVENTION

1. Technical Field

The present invention relates to authentication in a home network and, more particularly, to a level-specific authentication system and method in a home network, the system and method being capable of distinguishing user stations according to the number of authentication levels so as to differentially provide various services that are provided in the home network.

2. Related Art

An existing authentication algorithm for a wireless local area network (LAN) is a type of port-controlled algorithm which has a control function which provides services only to a station authorized through a predetermined authentication procedure so as to provide service in conformity with an IEEE 802.1x standard.

The IEEE 802.1x standard is defined in a controlled state and an uncontrolled state according to whether access control of an access point (AP) is possible. The IEEE 802.1x standard generally defines three kinds of entities: supplicant, authenticator and authentication server.

The supplicant is an entity that transmits credential information of a user to the authenticator when receiving a request for authentication from the authenticator, and that corresponds to a user station. The authenticator is an entity that requests authentication from the supplicant, and that requests an authentication service from the authentication server by using the received credential information of the user, of which the AP takes charge. Further, the authenticator manages the state of an access port of the corresponding user so as to set the port in either an authenticated state or an unauthenticated state depending on the result of authentication of the authentication server.

The authentication server is an entity that receives the request to authenticate the user from the authenticator so as to provide the authentication service. The authentication server should have the user credential information in advance. The authentication server is separated logically from the authenticator in a functional aspect, but it is not necessarily physically separated from the authenticator.

The IEEE 802.1x standard specifies the overall authentication mechanism between the supplicant, the authenticator and the authentication server, and prescribes that an extendable authentication protocol (EAP) should be used between the supplicant and the authenticator at a medium access control (MAC) layer.

### SUMMARY OF THE INVENTION

It is, therefore, an objective of the present invention to provide a level-specific authentication system and method in a home network, wherein stepped authentication levels are endowed to a plurality of stations obtaining access to an AP as well as to provision services, and according to the authentication levels endowed to the stations, it is determined whether a specific service can be used.

To achieve the objective, according to one aspect to the present invention, there is provided a level-specific authentication method in a home network based on a wireless local area network. The authentication method comprises: endowing any one of authentication levels to each of a plurality of user stations obtaining access to an access point, and to each of services provided by a plurality of service servers, the authentication levels being divided into a plurality of steps; and, when each user station obtains access to the access point to make a request for the specified service, comparing the authentication level endowed to each user station with the authentication level of the service requested by each user station, and allowing each user station the requested service according to a result of the comparison.

In the latter regard, allowing each user station the requested service may be possible only when the authentication level endowed to each user station is equal to or greater than the authentication level of the service requested by each user station.

In endowing the authentication level, data related to the authentication level endowed to each user station may include information on at least one of a service level of the corresponding user station, a type of service disallowed to the corresponding user station, and an allowable time of the service endowed to the corresponding user station.

Furthermore, in endowing the authentication level, data related to the authentication level endowed to each user station may include information on a minimum service authentication level of the user station for which the services provided by the corresponding server are allowed.

Meanwhile, allowing each user station the requested service may further comprise: sending, by the user station, an Associate-Request message to the access point; sending, by the access point receiving the Associate-Request message, an Associate-Response message to the user station; providing, by the user station associated with the access point through the two sending steps, access to the access point so as to register credential information of the user station; and searching, by the access point, the authentication level of the service endowed to each user station on a database through the credential information of the user station, and endowing the searched service authentication level to each user station.

The credential information of the user station may include an identifier endowed to the user station and a password for the corresponding identifier.

According to another aspect of the present invention, there is provided a level-specific authentication system in a home network based on a wireless local area network. The authentication system comprises: a service manager for storing an authentication level for each of a plurality of user stations obtaining access to an access point, and for each service provided by a plurality of service servers; and an access point for comparing the authentication level endowed to each user station with the authentication level of the service requested by each user station when each user station gets access to the access point to make a request for the specified service, and allowing each user station the requested service according to a result of the comparison.

In the latter regard, the allowance of the requested service to each user station may be possible only when the authentication level endowed to each user station is equal to or greater than the authentication level of the service requested by each user station.

The access point may include: a service database for storing information as to the authentication levels for each user station obtaining access to the access point, and for each service server providing the variety of services; and an associate table for receiving and storing data as to the association between the user stations and the access point, and information as to the authentication in the service database.

The service database may include: a provision service-specific level table having information on the authentication level of the service provided for each service server; and a user station-specific level table having information on the authentication level endowed to each user station obtaining access to the access point.

The user station-specific level table may include information on at least one of a service level of the corresponding user station, a type of service disallowed to the corresponding user station, and an allowable time of the service endowed to the corresponding user station.

The provision service-specific level table may include information on a minimum service authentication level of the user station for which the services provided by the corresponding server are allowed.

The access point further may include a packet filter for performing packet filtering control of a lower layer depending on the authentication level information included in the service database.

According to yet another aspect of the present invention, there is provided a level-specific authentication system in a home network based on a wireless local area network. The authentication system comprises: an access point to which a plurality of stations obtain access; at least one service server cooperating with the access point and providing a variety of services; and an authentication server for endowing any one of authentication levels, divided into a plurality of steps, to each of the plurality of stations obtaining access to the access point, and endowing any one of the plurality of authentication levels to each of the service servers. When each user station obtains access to the access point to make a request for the specified service, the authentication server allows the service requested by the corresponding station only when the authentication level endowed to each user station is equal to or greater than the authentication level of the service requested by each user station.

The authentication server may include a service database for storing information of the authentication levels for each user station obtaining access to the access point and for each service server providing the variety of services.

In the latter regard, the service database may include a provision service-specific level table having information on the authentication level of the service provided for each service server, and a user station-specific level table having information on the authentication level endowed to each user station obtaining access to the access point.

According to another aspect of the present invention, there is provided an authentication system in a home network, wherein the authentication system comprises: a service manager for storing an authentication level for each of a plurality of user stations obtaining access to an access point, and to each of the services provided by a plurality of service servers; and a home network control server for comparing the authentication level endowed to each user station with the authentication level of the service requested by each user station when each user station obtains access to the access point to make a request for the specified service, and for allowing each user station the requested service according to a result of the comparison.

In the latter regard, the home network control server may be a home server, a home gateway, a personal computer, a television, or a set-top box.

The home network control server may also include a service database for storing information as to the authentication levels for each user station obtaining access to the home network control server and for each service server providing the variety of services.

The service database may include a provision service-specific level table having information on the authentication level of the service provided for each service server, and a user station-specific level table having information on the authentication level endowed to each user station obtaining access to the access point.

According to yet still another aspect of the present invention, there is provided a differential authentication method, the method comprising the steps of: endowing any one of a plurality of authentication levels to each of a plurality of user stations obtaining access to an authentication server, the authentication levels being divided into a plurality of steps; endowing any one of the plurality of authentication levels to each of a plurality of service servers providing a plurality of services; and, when each user station obtains access to the access point to make a request for the specified service, allowing each of the user stations the requested service only when the authentication level endowed to each of the user stations is equal to or greater than the authentication level of the service requested by each of the user stations.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a flow diagram of an authentication process in accordance with a wireless local area network (LAN) standard;

FIG. 2 is a diagram of a configuration of a level-specific authentication system according to the present invention;

FIG. 3 is a diagram of an exemplary embodiment of an allowable level table for each provision service in accordance with the present invention;

FIG. 4 is a diagram of an exemplary embodiment of an allowable level table for each station in accordance with the present invention;

FIG. 5 is a diagram of an exemplary embodiment of an associate table of an access point (AP) in accordance with the present invention;

FIG. 6 is a diagram of an exemplary embodiment for endowing a level in a home network in accordance with the present invention; and

FIG. 7 is a diagram of a process in which a mobile station obtains access to a home network and is endowed with an authentication level in accordance with the present invention.

### DETAILED DESCRIPTION OF THE INVENTION

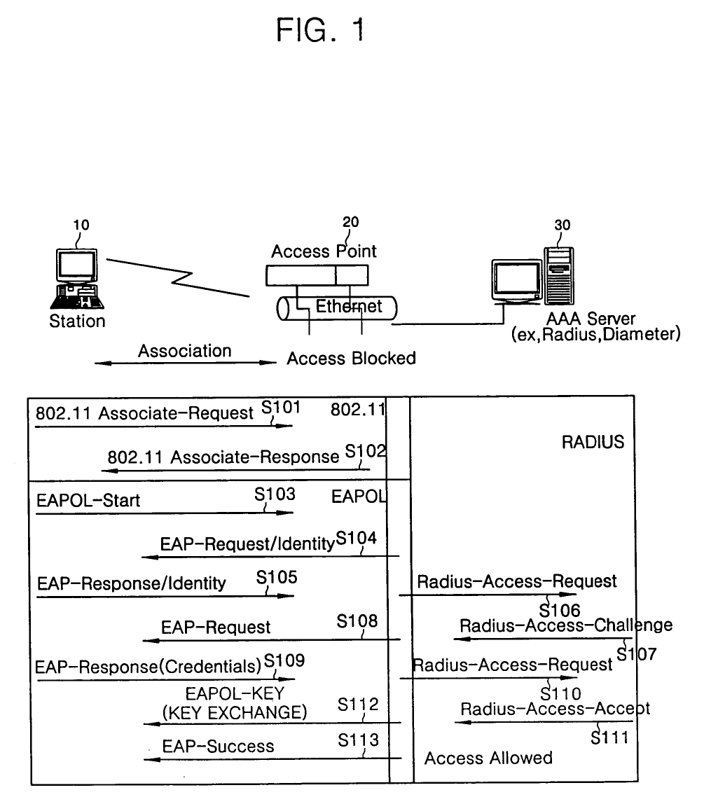

FIG. 1 is a flow diagram of an authentication process in accordance with a wireless local area network (LAN) standard. More specifically, FIG. 1 shows one example of an extendable authentication protocol over local area network (EAPOL) exchange process in an 802.11 network. The EAPOL exchange is substantially identical to an EAP exchange. The main differences therebetween are that, in the EAPOL exchange process, the supplicant can issue an EAPOL-Start frame in order to initiate the EAP exchange, and that the station can use an EAPOL-Logoff message in order to terminate authority of the port when terminating use of the network.

In the example described in FIG. 1, it is assumed that a Remote Authentication Dial-in User Service (RADIUS) server 30 is used as a back-end authentication server. This shows that an authenticator 20 performs transmission from a front-end EAP to the back-end RADIUS. EAP authentication by the RADIUS is defined in RFC 2869.

A supplicant 10 makes an 802.11 associate-request with respect to the authenticator 20 (S101). The authenticator 20 makes an 802.11 associate-response with respect to the 802.11 associate-request (S102), and then an EAPOL process is initiated.

The supplicant 10 initiates 802.1 x exchange with the EAPOL-Start message (S103). Normal exchange of EAP is initiated, and the authenticator 20 issues an EAP-Request/Identity frame (S104). The supplicant 10 responds to the EAP-Request/Identity frame with an EAP-Response/Identity frame (S105). In this response, a RADIUS-Access-Request packet is sent to the RADIUS server 30 (S106).

The RADIUS server 30 responds to the RADIUS-Access-Request packet with a RADIUS-Access-Challenge packet (S107). In this response, an EAP-Request of a proper authentication type that includes related challenge information is sent to the supplicant 10 (S108). The supplicant 10 collects the responses from the user in order to send an EAP-Response (S109). The responses are converted by the authenticator 20 into the RADIUS-Access-Request, which is a response to the challenge as a data field (S110).

The RADIUS server 30 accepts the access with a RADIUS-Access-Accept packet (S111). The authenticator 20 endows the supplicant 10 with an EAPOL-Key (S112), and issues an EAP-Success frame to the supplicant 10 (S113). Thereby, the port is endowed with authority so that the user can initiate use of the network. At this point in time, Dynamic Host Configuration Protocol (DHCP) can be set.

When the use of the network is terminated, the supplicant 10 sends an EAPOL-Logoff message in order to return the port to an unauthorized state.

As discussed above, the 802.1x based authentication protocol is currently used as the basis of the wireless LAN. The existing mechanism is a kind of port control, which employs a dichotomic control mechanism with only two divided states: authenticated state and unauthenticated state. This mechanism makes it impossible to provide the differential services because there is no definition of functions of selectively providing services to providers having service resources.

Hereinafter, exemplary embodiments of the invention will be described in detail with reference to the accompanying drawings.

In the present invention, the exemplary embodiments will be mainly described as centering on an access point (AP) in a wireless local area network (LAN)-based home network. However, it should be noted that the differential authentication service method of the present invention is a concept capable of being widely applied to various home servers, home gateways, PCs, TVs, set-top boxes, etc. in various wired and/or wireless home networks.

The present invention includes a process of registering a station with an AP in a home network system, a process of endowing service authority to the station, a method of using an authentication level, and so forth.

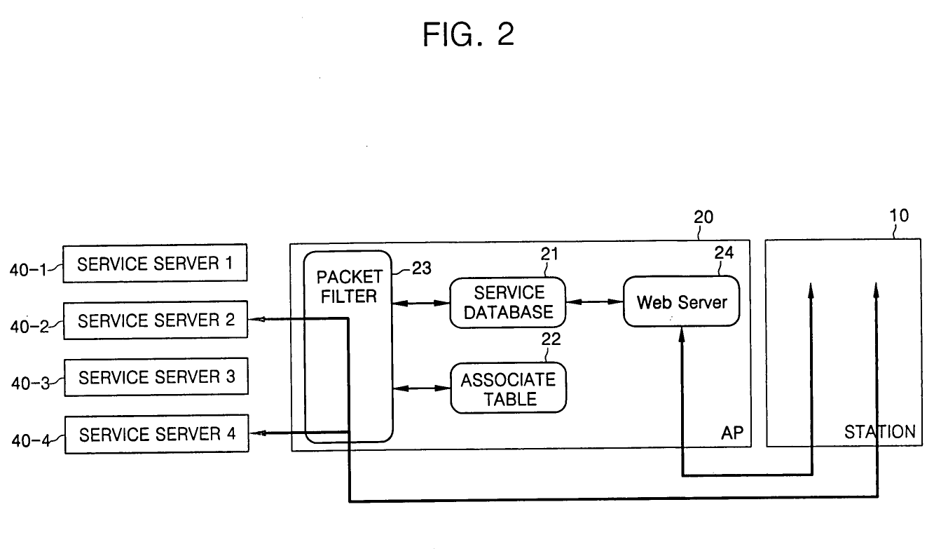

FIG. 2 is a diagram of a configuration of a level-specific authentication system according to the present invention.

The level-specific authentication system is generally composed of a station 10, an AP 20, and a plurality of service servers 40-1, 40-2, 40-3 and 40-4.

The AP 20, which takes charge of the main functions in the present invention, includes a service database 21, an associate table 22, a packet filter 23, and a web server 24.

The service database 21, established to endow an authentication level for each station and each service, may be configured so as to provide access to the AP 20 in a separate authentication server. However, in the present invention, the service database 21 is configured so as to be located in the AP 20.

The associate table 22 includes data obtained by adding information on the authentication levels, according to the present invention, to the associate table 22 within the existing AP 20.

Exchange of frames between the station 10 and the AP 20 is possible because the station 10 is registered or associated with the AP 20. As such, the associate table 22 includes data related to association between the station 10 and the 20.

The packet filter 23 is configured to achieve, in a lower layer, the objective that the service database 21 is intended to accomplish, and the packet filter 23 performs packet filtering control according to the authentication level information which is included in the service database 21. In other words, the packet filter 23 is a module for determining whether each station is capable of obtaining access to the service servers 40-1, 40-2, 40-3 and 40-4 on the basis of the authentication levels, and performs packet filtering on the basis of the authentication level applied on registering the station 10.

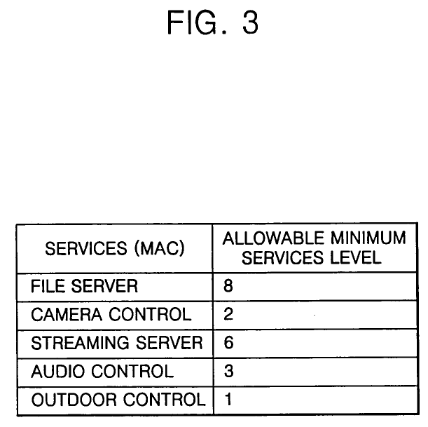

FIG. 3 is a diagram of an exemplary embodiment of an allowable level table for each provision service in accordance with the present invention.

A service manager stores information in the form of a table as shown in FIG. 3 in the service database with regard to services provided in the home network within a basic service set (BSS). The BSS is managed by the service manager. These data are used in the packet filter 23 within the AP 20 for service-specific packet filtering as discussed with reference to FIG. 2. The packet filter 23 takes charge of the function of filtering and supplying only a specified service that is allowed to a specified station by use of the authentication level of each service, information on MAC addresses, and information on IP addresses that are stored in the database.

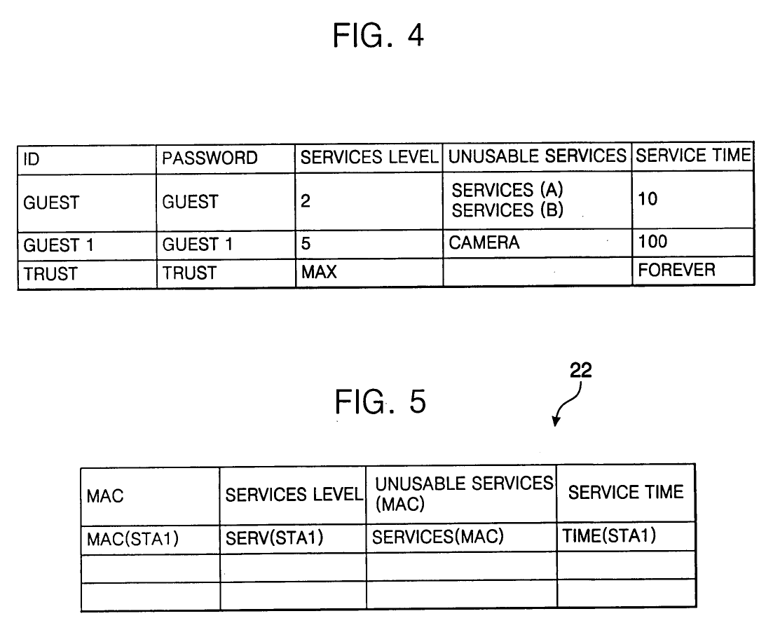

FIG. 4 is a diagram of an exemplary embodiment of an allowable service table for each station in accordance with the present invention.

The table of FIG. 4 is correlates an identifier (ID) pool, a password pool, and an allowable service for each ID according to the authentication level with regard to each station obtaining access to the AP 20.

In FIG. 4, the three stations have IDs of ‘guest,’ ‘guest1’ and ‘trust’, and passwords identified to the respective IDs. The station with the ID of ‘guest’ has a service level of 2, unusable services of A and B, and a service time of 10 hours. The station with the ID of ‘guest1’ has a service level of 5, an unusable service of Camera, and a service time of 100 hours. The station with the ID of ‘trust’ has a service level of Max., unusable services of None, and a service time of Forever.

The service database 21 located in the AP 20 of FIG. 2 includes the above-mentioned tables of FIGS. 3 and 4. When a separate authentication server is provided, the service database 21 of FIG. 2 may be located in the authentication server. In that regard, the station 10 obtains access to the authentication server via the AP 20.

FIG. 5 is a diagram of an exemplary embodiment of an associate table of an access point (AP) in accordance with the present invention.

The associate table 22 of FIG. 5 includes data for a service authentication level allowed to each station, an unusable service and a service time on the basis of a MAC address of each station getting access to the AP 20.

An associate table is generally used in an AP, but the associate table 22 located in the AP 20 according to the present invention further includes information on the authentication level, the unusable service and the service time of each station obtaining access to the AP 20.

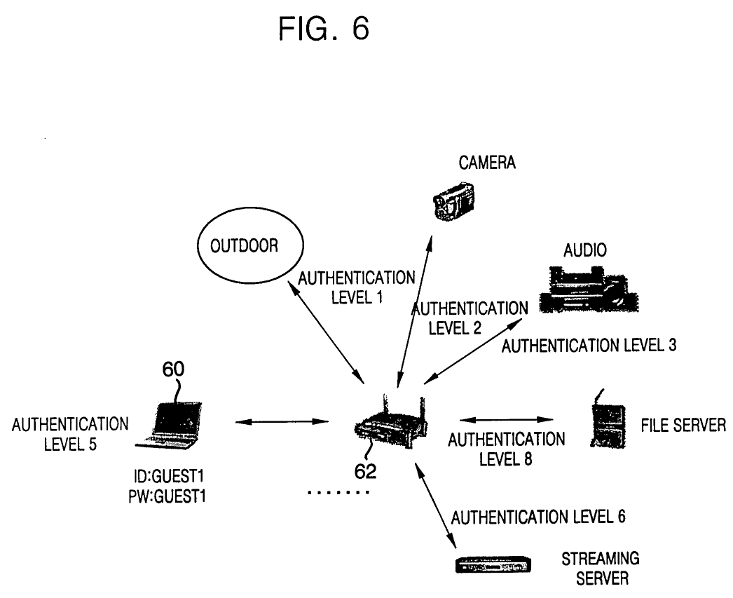

FIG. 6 is a diagram of an exemplary embodiment for endowing a level in a home network system according to the present invention.

When a station gets access to a home network area, and acquires and registers an ID and a password from the AP or the service manager, the station is allocated an authentication level that has been already determined by the service manager. At this point, the station is capable of checking a list of services that can be provided through an authentication level management web server in the AP. If a certain station provides access to an unallowable service, the station is automatically subjected to restriction to a packet by the AP. In addition, when a predetermined time has lapsed, the station may be subjected to restriction as to use.

In the embodiment of FIG. 6, the higher the level allocated to the station, the more types of accessible services are available. If necessary, the maximum level accessible to all of the services may be designated to the lowest number, and then access to a lower level may be allowed in proportion to an increase in the number.

The station 60 shown in FIG. 6 is endowed with a user ID of ‘guest1’ and a password of ‘guest1’ and is allocated an authentication level of 5. In other words, the station 60 has access only to services having an authentication level of 5 or less. With regard to the authentication level allocated to each service, the authentication level of 1 is for the outdoor network, 2 is for the camera, 3 is for the audio, 6 is for the streaming server, 8 is for the file server, and so forth.

For example, as seen in FIG. 6, when the station 60 to which the ID and the password of ‘guest1’ are allocated registers the ID and the password, the corresponding items related to the station 60 are searched from the database already possessed by the AP 62, and are then registered as the following information: “the authentication level of 5, the unusable service of Camera, the usable time after the association of 100 hours.”

In the case of the home network system of FIG. 6, the station 60 can use any service having an authentication level lower than 5 exclusive of Camera, namely, the outdoor network (the authentication of 1) and the audio (the authentication of 3), for 100 hours. If the station 60 obtains access to a file server or streaming server having an authentication level lower than 5, the AP 62 interrupts and discards any packet obtaining access to the MAC address of a service device having the high authentication level with reference to the associate table 22, so that it is possible to provide the restricted services.

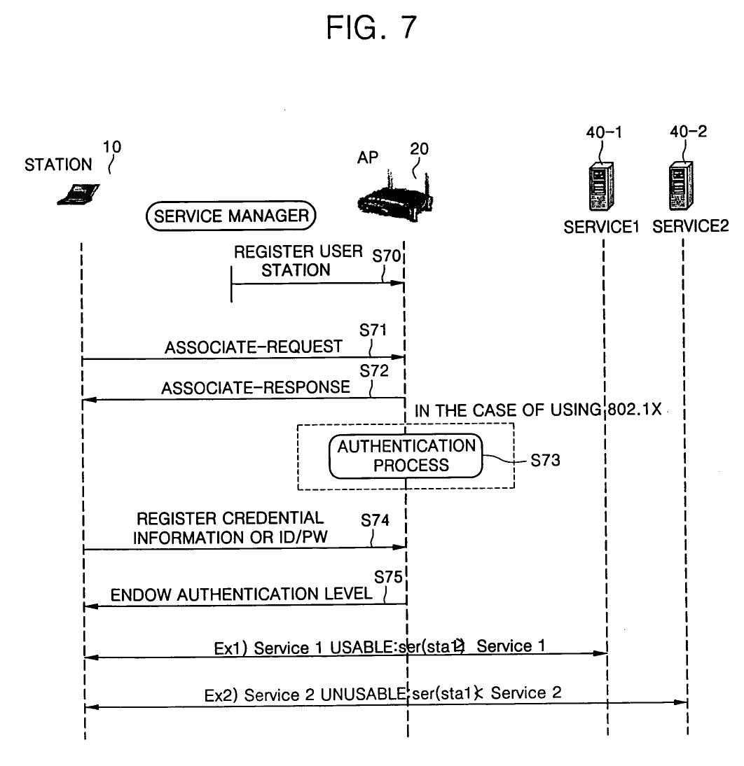

FIG. 7 is a diagram of a process in which a mobile station obtains access to a home network and is endowed with an authentication level in accordance with the present invention.

When the station 10 is allocated an authentication level, the AP 20 informs the station of resources of the home network that can be provided for each level and ID through a web server. Further, the AP 20 provides ID, password and usable period of time according to a step of providing services. When the usable period of time has expired, the AP 20 forcibly makes a request for disassociation to interrupt the services or lower the service level for the station 10, thereby being capable of presenting a criterion or basis of service provision or interruption.

In order to perform level-specific authentication according to the present invention, it is presumed that the service manager should register the stations to be used in the home network with the AP 20 (S70). Information on the usable stations to be registered will be contained in the tables discussed above with reference to FIGS. 3 and 4, such as IDs and passwords of the corresponding stations, and authentication levels endowed to the corresponding stations.

A database for the stations registered by the service manager may be further added in the future, or may be deleted.

The station 10 transmits an associate-request message to the AP 20 in order to make a request for association (S71), and the AP 20 transmits an associate response message to the station 10 (S72). Then, in the case of using the 802.1x standard, a separate authentication process is performed (S73).

When the station 10 is associated with the AP 20, the station 10 has a minimum authentication level if the station is not registered with the AP 20. The station 10 obtains access to a web or home server located in the AP 20, and then registers its ID and password, or credential information, with the web server 24 located in the AP 20. The ID and password of the station 10 are endowed by the service manager.

When the station 10 obtains access to the AP 20 and registers the ID and password (S74), the AP 20 allocates the authentication level that is predetermined by the service manager to the corresponding station 10 with reference to the data stored in the table of FIG. 4 (S75). At this point, the station 10 can check a list of allowable services through the authentication level management web server 24. In this case, the AP 20 prepares authentication level, usable time, and unallowable service items for each station, and stores them in the associate table 22.

In the embodiment of FIG. 7, if the authentication level allocated to the station 10 is equal or greater than the provision service level of 1, in accordance with the embodiment of the invention, it is possible to make use of the services corresponding to the provision service level of 1 through the station 10. However, in the case of a provision service level of 2, it is impossible to make use of the services corresponding to the provision service level of 2.

With the present invention having the features as mentioned above, the stations are divided according to various authentication levels in the wireless LAN based home network. As a result, various services are differentially provided in the home network. Thus, the previously authenticated wireless stations are automatically authenticated without re-authentication, thereby obtaining convenience in use.

Furthermore, when an outdoor visitor makes an indoor visit to provide access to the home network and intends to obtain predetermined services, temporary authentication can be provided only for an allowable time which is requested. In other words, for a given time, the authentication level controls whether specified services are used, so that it is possible to provide new services in the home network.

For example, one may be allowed to obtain access to the home network only for a day so as to be capable of copying data stored in the PC, such as travel photographs, into his/her mobile phone. In addition, service coverage of the station may be restricted so as to prevent children from playing on-line games for a test period of time.

The present invention divides the stations obtaining access to the AP in the wireless LAN based home network according to a plurality of authentication levels, thereby providing for a dichotomic authentication procedure proposed by the 802.1x standard and restricting services by means of the authentication level for obtaining access to the home network. Accordingly, it is possible to escape from the uniform authentication or non-authentication of the station and service server, thus realizing a level-specific authentication system.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. A level-specific authentication method in a home network based on a wireless local area network, the authentication method comprising the steps of:
endowing any one of a plurality of authentication levels to each of a plurality of user stations obtaining access to an access point and to each of a plurality of services provided by a plurality of service servers, the authentication levels being divided into a plurality of steps; and
when each user station obtains access to the access point to make a request for a specified service, comparing the authentication level endowed to each user station with the authentication level of the service requested by each user station, and allowing said each user station the requested service according to a result of the comparison.

2. The authentication method according to claim 1, wherein the step of allowing said each user station the requested service is possible only when the authentication level endowed to said each user station is at least equal to and not less than the authentication level of the service requested by said each user station.

3. The authentication method according to claim 1, wherein, in the step of endowing said any one of the plurality of authentication levels to said each of the plurality of user stations, data related to the authentication level endowed to said each user station include information on at least one of a service level of the corresponding user station, a type of the service disallowed to the corresponding user station, and an allowable time of the service endowed to the corresponding user station.

4. The authentication method according to claim 1, wherein, in the step of endowing said any one of the plurality of authentication levels to said each of the plurality of user stations, data related to the authentication level endowed to said each of the plurality of services provided by the plurality of service servers include information on a minimum service authentication level of said user station to which services provided by a corresponding server are allowed.

5. The authentication method according to claim 1, wherein the step of allowing said each user station the requested service further comprises:
sending, by means of said each user station, an Associate-Request message to the access point;
sending, by means of the access point receiving the Associate-Request message, an Associate-Response message to said each user station;
obtaining, at said each user station associated with the access point through the two sending steps, access to the access point so as to register credential information of said each user station; and
searching, at the access point, a database using the credential information of said each user station to identify an authentication level of the service endowed to said each user station, and endowing the identified authentication level to said each user station.

6. The authentication method according to claim 5, wherein the credential information of said each user station includes an identifier endowed to said each user station and a password for the endowed identifier.

7. A level-specific authentication system in a home network based on a wireless local area network, the authentication system comprising:
a service manager for storing a service authentication level endowed to each of a plurality of user stations and to each of a plurality of services provided by a plurality of service servers; and
an access point for comparing the authentication level endowed to each user station with the authentication level of the service requested by said each user station when said each user station obtains access to the access point to make a request for a specific service, and for allowing said each user station the requested service according to a result of the comparison.

8. The authentication system according to claim 7, wherein the allowance of said each user station the requested service is possible only when the authentication level endowed to said each user station is at least equal to and not less than the authentication level of the service requested by said each user station.

9. The authentication system according to claim 7, wherein the access point includes:
a service database for storing information on the authentication levels for said each user station obtaining access to the access point, and for each service server providing the plurality of services; and
an associate table for receiving and storing data on an association between said each user station and the access point, and information on the authentication levels stored in the service database.

10. The authentication system according to claim 9, wherein the service database includes:
a provision service-specific level table having information on the authentication level for said each service server; and
a user station-specific level table having information on the authentication level for said each user station obtaining access to the access point.

11. The authentication system according to claim 10, wherein the user station-specific level table includes information on at least one of a service level of a given user station, a type of service disallowed the given user station, and an allowable time of service endowed to the given user station.

12. The authentication system according to claim 10, wherein the provision service-specific level table includes information on a minimum service authentication level of said each user station for which services provided by a corresponding server are allowed.

13. The authentication system according to claim 9, wherein the access point comprises a packet filter for performing packet filtering control of a lower layer depending on the authentication level information which the service database includes.

14. A level-specific authentication system in a home network based on a wireless local area network, the authentication system comprising:
an access point to which a plurality of stations obtain access;
at least one service server cooperating with the access point and providing a plurality of services; and
an authentication server for endowing any one of a plurality of authentication levels, divided into a plurality of steps, to each of the plurality of stations obtaining access to the access point, and for endowing any one of the plurality of authentication levels to said at least one service server;
wherein, when said each of the plurality of user stations gets access to the access point to make a request for a specified service, the authentication server allows the specific service requested by said each of the plurality of user stations only when the authentication level endowed to said each of the plurality of user stations is at least equal to and not less than the authentication level of the service requested by said each of the plurality of user stations.

15. The authentication system according to claim 14, wherein the authentication server includes a service database for storing information on the authentication levels for said each of the plurality of user stations obtaining access to the access point, and for each said at least one service server providing the plurality of services.

16. The authentication system according to claim 15, wherein the service database includes:
a provision service-specific level table having information on the authentication level for each said at least one service server; and
a user station-specific level table having information on the authentication level for said each user station obtaining access to the access point.

17. An authentication system in a home network, comprising:
a service manager for storing an authentication level endowed to each of a plurality of user stations, and to each of a plurality of services provided by a plurality of service servers; and
a home network control server for comparing the authentication level endowed to each user station with the authentication level of the service requested by each user station when said each user station makes a request for a specific service, and for allowing said each user station the requested service according to a result of the comparison.

18. The authentication system according to claim 17, wherein the home network control server is any one of a home server, a home gateway, a personal computer, a television, and a set-top box.

19. The authentication system according to claim 18, wherein the home network control server includes a service database for storing information on the authentication levels for said each user station obtaining access to the home network control server, and for each service server providing the plurality of services.

20. The authentication system according to claim 19, wherein the service database includes:
a provision service-specific level table having information on the authentication level for said each service server providing the plurality of services; and
a user station-specific level table having information on the authentication level for said each user station.

21. The authentication system according to claim 20, wherein the user station-specific level table includes information on at least one of a service level of a given user station, a type of service disallowed the given user station, and an allowable time of service endowed to the given user station.

22. A differential authentication method, comprising the steps of:
endowing any one of a plurality of authentication levels to each of a plurality of user stations obtaining access to an authentication server, the authentication levels being divided into a plurality of steps;
endowing any one of the plurality of authentication levels to each of a plurality of service servers providing a plurality of services; and
when a given user station obtains access to the access point to make a request for a specific service, allowing said given user station the requested service only when the authentication level endowed to said given user station is at least equal to and not less than the authentication level of the service requested by said given user station.
